(19) United States
(12) Patent Application Publication
(10) Pub. No.: US 2019/0195193 A1
(43) Pub. Date: Jun. 27, 2019

(54) ROTOR BLADE HUB FOR A WIND TURBINE, AND WIND TURBINE HAVING SAME

(71) Applicant: Wobben Properties GmbH, Aurich (DE)

(72) Inventors: Albrecht BRENNER, Aurich (DE); Jochen RÖER, Ganderkesee (DE); Jan Carsten ZIEMS, Aurich (DE)

(21) Appl. No.: 16/329,505

(22) PCT Filed: Aug. 22, 2017
(86) PCT No.: PCT/EP2017/071120

§ 371 Date: Feb. 28, 2019

(30) Foreign Application Priority Data
Aug. 31, 2016 (DE) 10 2016 216 458.9

(51) Int. Cl. F03D 1/06; F03D 15/00

(52) U.S. Cl. CPC F03D 1/0691; F03D 15/00; F05B 2260/966; F05B 2260/404; F05B 2240/60

(57) ABSTRACT

Provided is a rotor blade hub for a wind turbine. The rotor blade hub includes a connecting portion for torque-transmitting coupling of the rotor blade hub to a main shaft of the wind turbine. The rotor blade hub has a single-stage transmission which is non-rotatably mounted to the rotor blade hub at the drive input side and has the connecting portion at the drive output side.

### BACKGROUND

### Technical Field

The present invention relates to a rotor blade hub for a wind turbine, comprising a connecting portion for torque-transmitting coupling of the rotor blade hub to a main shaft of the wind turbine. The invention further relates to a wind turbine having such a rotor blade hub, a generator for generating electric power, wherein the generator has a generator rotor and a generator stator, and wherein the generator rotor and the rotor blade hub are coupled with a main shaft.

### Description of the Related Art

Wind turbines of the above-indicated kind are generally known. On the one hand wind turbines have become established in the state of the art, in which the rotor blade hub is coupled to the generator by means of a frequently multi-stage transmission, wherein the multi-stage transmission implements a step-up of the drive movement which is predetermined by the rotor blade hub to a higher rotary speed. In high loading situations the transmissions known from the state of the art exhibit an increased susceptibility to faults and defects. Wind turbines with a drive train including a transmission usually have an asynchronous generator which by virtue of the principle involved needs high rotary speeds. Wind turbines with a transmission are typically designed in such a way that the hub is connected at the drive output side to the main shaft leading to the transmission. That main shaft transmits not only the drive moment of the wind turbine but also the loadings resulting from the wind, turbulence, the dynamics and the inherent weight of the hub. As a result, as the rotating component, the main shaft is subjected to considerable stress variations and is to be of appropriate dimensions.

In comparison transmission gear-less wind turbines have become established in the state of the art, in particular by the present applicant, such wind turbines using a slowly rotating, multi-pole synchronous generator. Gear-less installations are typically mounted directly within the hub on a stationary journal, whereby external loadings are diverted into the pylon by way of substantially stationary structural elements.

Slowly rotating multi-pole synchronous generators are maintenance-friendly and reliable, but they require a large generator diameter by virtue of the principle involved in order, because of the low rotary speeds, nonetheless to be able to ensure sufficient electric power generation. There is a need for improvement in that respect by virtue of the trend towards ever higher power classes markedly above 4 megawatts.

### BRIEF SUMMARY

Improving a rotor blade hub is provided herein to permit use in combination with generators of smaller and lighter structure, while the advantages of the stationary drive train concept are retained to the best possible extent. In addition the efficiency in producing electric power should remain unaffected as much as possible.

In a rotor blade hub of the kind set forth in the opening part of this specification that object is attained by designing a hub. In particular, provided is a rotor blade hub having a single-stage transmission which is non-rotatably mounted to the rotor blade hub at the drive input side and has a connecting portion at the drive output side. Preferably a shaft/hub connection is provided in the connecting portion between the single-stage transmission and the main shaft.

A drive train of the wind turbine is provided. Placement of a single-stage transmission directly at the rotor blade hub makes it possible to have a hitherto unattained advantage in regard to maintenance and replacement of the transmission. The further drive train in the direction of the generator can remain unaltered, it is only necessary for the transmission to be arranged at the rotor blade hub. In addition a paradigm shift is possible by virtue of integration of a single-stage transmission in the rotor blade hub. Hitherto in particular slowly rotating synchronous generators were operated exclusively in a transmission gear-less structure. In the state of the art the provision of a transmission on wind turbines with a synchronous generator, in particular with a slowly rotating synchronous generator, has been even dismissed as a matter of principle, because that was not required.

It has however surprisingly been found that, by the selection of a merely single-stage transmission which entails a clear straightforward change in the transmission ratio it is possible to achieve an increase in efficiency in regard to the generation of electric power. In comparison with conventional wind turbines the rotor blade hub according to the disclosure makes it possible to operate smaller generators at a higher speed of rotation by virtue of the step-up transmission of the single-stage transmission. That means that, in comparison with the conventional installations in a given power class, generators of a smaller and significantly lighter structure can now be used for the same power class in the wind turbine while the advantages of the gear-less drive train are retained.

The single-stage transmission is preferably a step-up transmission with a transmission ratio in a range of 1:1.5 to 1:10.

Preferably the single-stage transmission is in the form of a planetary transmission having a sun gear, a planetary carrier having a number of planetary gears and a ring gear, wherein the planetary gears are in engagement with the sun gear and the ring gear. In a preferred configuration the sun gear of the planetary transmission is non-rotatably connected to the connecting portion at the drive output side or has said connecting portion. Planetary transmissions have the advantage that they are robust, take up a small amount of space, in particular in the axial direction, and involve more moderate friction losses. A deterioration in the overall level of efficiency in producing electric power by using a planetary transmission is compensated by the increase in power generation by virtue of the higher rotary speed.

There are various equally preferred options for driving the main shaft by means of the single-stage transmission. In accordance with a first preferred option the planetary carrier of the planetary transmission is non-rotatably connected to the rotor blade hub at the drive input side. Further preferably the connecting portion is a first connecting portion and the ring gear further has a second connecting portion for non-rotatable connection to a journal of the wind turbine. The journal is preferably used to mount the rotor blade hub in generally known fashion. That affords the advantage that all the forces due to weight and wind loads are guaranteed to be carried in known manner by the journal so that the single-stage transmission and the main shaft have to transmit exclusively the torque from the rotor blade hub to the generator.

In an alternative preferred embodiment the connecting portion is a first connecting portion and the planetary carrier has a second connecting portion for non-rotatable connection to a journal of the wind turbine. Further then the ring gear of the planetary transmission is non-rotatably connected to the rotor blade hub at the drive input side.

The foregoing considerations relate to a planetary transmission. A single-stage transmission can also be preferably implemented by means of a magnetic transmission. In a further preferred embodiment accordingly the single-stage transmission is in the form of a magnetic transmission which instead of the sun gear has an inner permanent-magnetic ring, instead of the planetary carrier it has a ferromagnetic intermediate ring, and instead of the ring gear it has an outer permanent-magnetic ring. Preferably the inner magnetic ring of the magnetic transmission is non-rotatably connected to the connecting portion at the drive output side. Further preferably the ferromagnetic ring of the magnetic transmission is non-rotatably connected to the rotor blade hub at the drive input side. The connecting portion is preferably a first connecting portion and the outer permanent-magnetic ring has a second connecting portion for non-rotatable connection to the journal of the wind turbine. As an alternative thereto the connecting portion is a first connecting portion and the ferromagnetic ring has a second connecting portion for non-rotatable connection to a journal of the wind turbine. Preferably then the outer permanent-magnetic ring of the magnetic transmission is non-rotatably connected to the rotor blade hub at the drive input side.

The invention has been described hereinbefore in relation to a first aspect with reference to the rotor blade hub. Provided is a wind turbine of the kind set forth in the opening part of this specification, in that the rotor blade hub is designed in accordance with one of the above-described preferred embodiments. The generator is particularly preferably a synchronous generator. Further preferably the synchronous generator is in the form of a slowly rotating, multi-pole synchronous generator. Particularly preferably it is a ring generator.

The term slowly rotating generator is used to mean a generator which rotates at a speed of revolution of 100 revolutions per minute or less.

The term multi-pole generator is used to denote a generator having at least 48, 96 and in particularly at least 192 rotor poles.

The term ring generator is used to mean that the magnetically active regions of the rotor and stator, more specifically in particular the lamination assemblies of the stator and rotor, are arranged in an annular region around the air gap separating the stator and rotor. In that respect the generator in an inner region of a radius of at least 50% of the mean air gap radius is free from the magnetically active region.

A ring generator can also be defined in that the radial thickness of the magnetically active parts, or, in other words, the magnetically active region, namely the radial thickness from the inner edge of the pole wheel to the outer edge of the stator, or from the inner edge of the stator to the outer edge of the rotor, in the case of an external rotor, is less than the air gap radius, and in particular the radial thickness of the magnetically active region of the generator is less than 30%, in particular less than 25% of the air gap radius. In addition or alternatively ring generators can be defined by specifying that the depth, namely the axial extent of the generator, is less than the air gap radius, and in particular the depth is less than 30%, in particular less than 25% of the air gap radius.

In preferred configurations arising out of the foregoing description concerning the first aspect relating to the rotor blade hub the rotor blade hub is torque-transmittingly coupled to the main shaft of the wind turbine by means of a connecting portion, insofar as the rotor blade hub has a single-stage transmission which is non-rotatably mounted to the rotor blade hub at the drive input side and is non-rotatably connected to the main shaft at the drive output side. Preferably the wind turbine has a journal. Further preferably the journal is non-rotatably connected to the planetary carrier or ring gear of the planetary transmission, or non-rotatably connected to the ferromagnetic ring or the outer permanent-magnetic ring of a magnetic transmission.

The wind turbine preferably has a machine carrier, wherein the rotor blade hub is arranged on a first side of the machine carrier, the generator is arranged on the opposite second side of the machine carrier, and the main shaft which is preferably a hollow shaft is passed through the machine carrier and is non-rotatably connected to the generator rotor. The oppositely disposed arrangement of the rotor blade hub and the generator compensate for the tilting moments which are exerted by the two units and which act on the machine carrier, whereby overall this permits a further saving in weight by virtue of the use of smaller bearings.

In an alternative configuration the wind turbine has a machine carrier and a journal, wherein the generator is mounted in the form of a generator module directly to the machine carrier, the journal is mounted to the generator module or to the machine carrier, and the rotor blade hub is mounted rotatably on the journal. In that case the main shaft is also passed through the journal. This configuration retains the conventional arrangement of generator and rotor blade hub on the same side in relation to the machine carrier. It is considered to be advantageous that it is possible to have recourse to the tried-and-tested mounting concepts in regard to the journal, the rotor blade hub and the mounting of the rotor blade hub.

In a further preferred embodiment the single-stage transmission of the rotor blade hub is in the form of an ancillary attachment transmission and is mounted to a side of the rotor blade hub, that is remote from the machine carrier. By virtue of this configuration the single-stage transmission is disposed at the front end of the rotor blade hub. This further facilitates access to the single-stage transmission from the outside in order to maintain it, repair it or replace it. In addition changing the single-stage transmission and replacing it by a single-stage transmission with a different transmission ratio with the generator unchanged for adaptation of the power class of the wind turbine is structurally easier. That leads to a greater number of identical components over various power classes of wind turbines and affords power advantages in regard to costs, production and stock-keeping.

### BRIEF DESCRIPTION OF THE SEVERAL VIEWS OF THE DRAWINGS

The invention is described in greater detail hereinafter with reference to the accompanying Figures by means of preferred embodiments by way of example. In the Figures:

FIG. 1 shows a diagrammatic perspective view of a wind turbine,

FIG. 2 shows a diagrammatic cross-sectional view through a pod of the wind turbine of FIG. 1 in a first embodiment, and

FIG. 3 shows a diagrammatic cross-sectional view through the pod of the wind turbine as shown in FIG. 1 in a second embodiment.

### DETAILED DESCRIPTION

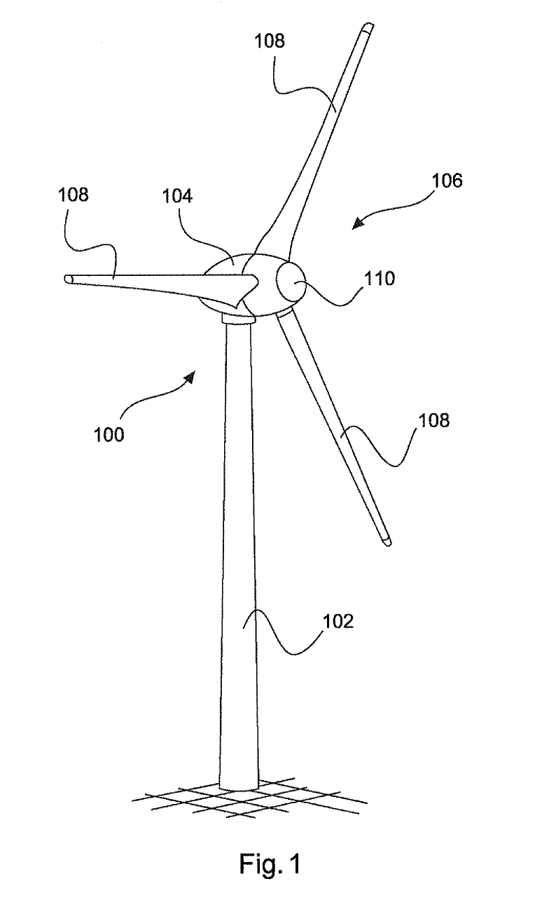

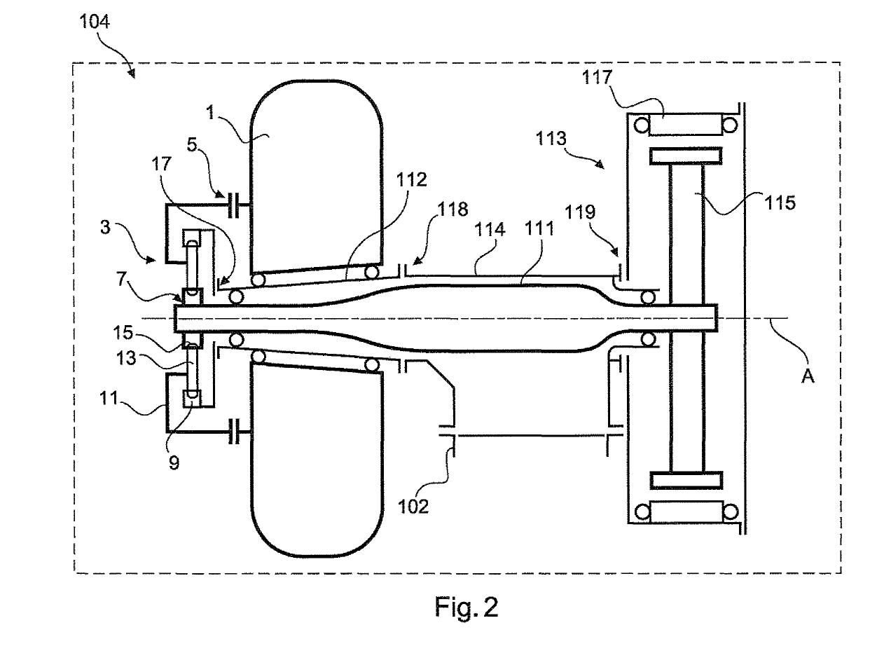

FIG. 1 shows a diagrammatic view of a wind turbine 100. The wind turbine 100 has a pylon 102 and a pod 104 on the pylon 102. Provided on the pod 104 is an aerodynamic rotor 106 having three rotor blades 108 and a spinner 110. In operation of the wind turbine 100 the aerodynamic rotor 106 is caused to rotate by the wind and thus also rotates the generator rotor or rotor member 115 (FIG. 2) of a generator 113 (FIG. 2) directly or indirectly coupled to the aerodynamic rotor 106. The electric generator 113 is disposed in the pod 104 and generates electric power.

FIG. 2 shows the internal structure of the pod 104 according to a first embodiment. The rotor blades 108 shown in FIG. 1 are connected to a rotor blade hub 1. The rotor blade hub 1 is mounted rotatably on a journal 112. The rotor blade hub 1 has a single-stage transmission connected to the rotor blade hub 1 by way of a corresponding connection 5. At the drive output side the single-stage transmission 3 has a connecting portion 7, at which the single-stage transmission 3 is non-rotatably coupled to a main shaft 111 of the wind turbine 104. The main shaft 111 constitutes the drive train to the generator 113.

The single-stage transmission 3 has a ring gear 9. A planetary carrier 11 is moved relative to the ring gear 9 by means of a number of planetary gears 13 which are in engagement with the ring gear. As a result a sun gear 15 of the single-stage transmission 3 which has the connecting portion to the main shaft 111 is driven in a stepped-up ratio. Preferably the ratio of the single-stage transmission is in the range of 1:2.5 to 1:5.

The main shaft 111 is passed through the journal 112 and a machine carrier 114 of the wind turbine 100 and non-rotatably connected to the generator rotor 115 of the generator 113. The generator rotor 115 is driven in rotation relative to a stator 117 by means of the hub 1, in which case the single-stage transmission 3 brings about a moderate step-up transmission effect and an increase in the rotary speed of the generator rotor 115 relative to the rotor blade hub 1.

In the embodiment shown in FIG. 2 the generator 113 is arranged in opposite relationship to the rotor blade hub 1, relative to the machine carrier 114. The generator 113 is fixed to the machine carrier 114 by means of a first connecting flange 119 while the journal 112 supporting the rotor blade hub 1 is connected to the machine carrier 114 at an oppositely disposed second connecting flange 118. The machine carrier 114 is connected to the pylon 102, preferably by means of a rotary connection (not shown). Reference A identifies the axis of rotation of the rotor blade hub 1 and the generator 115.

In the embodiment of FIG. 2 the single-stage transmission is connected to the main shaft at the sun gear 15 by means of a first connecting portion 7 and the sun gear 9 is non-rotatably connected to the journal 112 by means of a second connecting portion so that the sun gear 9 does not rotate about the axis A. By virtue of the connection at the connection 5 the planetary carrier 11 rotates at the same speed of rotation as the rotor blades connected to the rotor blade hub 1, about the axis A. A transmission step-up ratio acts on the sun gear 15 by means of the planetary gears 13.

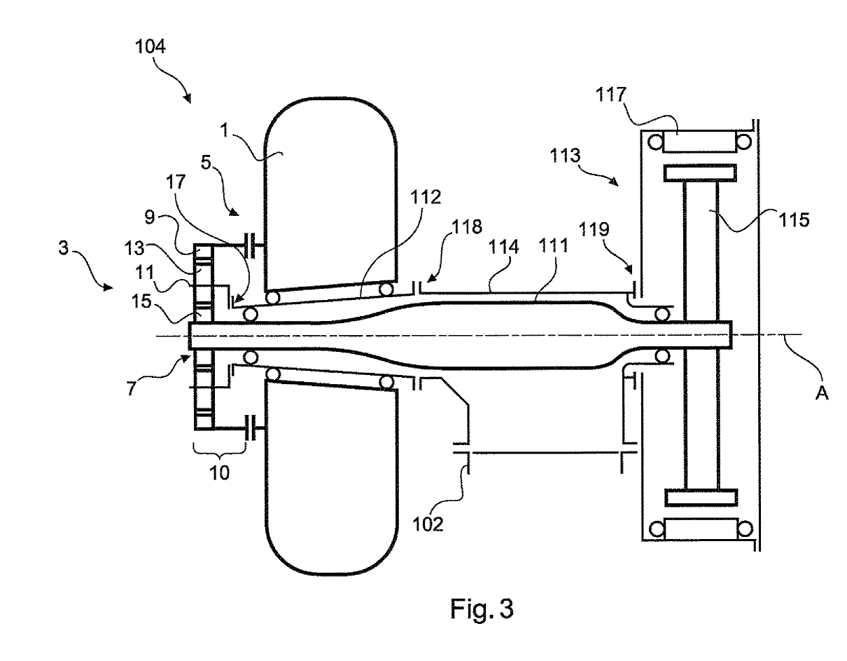

FIG. 3 is structurally similar to the embodiment of FIG. 2, in particular in regard to the arrangement of the generator 113 relative to the rotor blade hub 1 on different sides of the machine carrier 114. What distinguishes the embodiment of FIG. 3 from the embodiment of FIG. 2 is the connection of the single-stage transmission 3. In the FIG. 3 embodiment the ring gear 9 is connected directly to the rotor blade hub 1 by means of the connecting portion 5 and is synchronized therewith while the planetary carrier 11 is connected to the journal 112 by means of the second connecting portion 17 and is thus fixed. In this variant by way of a rotational movement of the ring gear 9 and a rotational movement of the otherwise stationary planetary gears 13 there is a step-up transmission action on the sun gear 15 which drives the main shaft 111 at an increased speed in comparison with the speed of rotation of the rotor blades 108.

In both embodiments shown in FIG. 2 and FIG. 3 the single-stage transmission 3 is arranged in the form of an attachment transmission 10 at the front end on the rotor blade hub 1 and is thus accessible from the end at any time without influencing the rest of the drive train.

As was described in detail hereinbefore the use of the single-stage transmission 3, in particular in its configuration in the form of the attachment transmission 10, permits uncomplicated adaptation of the respectively required transmission ratio to the installation conditions and the desired power class of the wind turbine 100, wherein different step-up transmission ratios in conjunction with always the same generator 113 can lead to different power yields. In comparison with a direct drive without transmission smaller generators can be used for the same power class, which affords massive savings in regard to the costs and the weight of the wind turbine 100, in particular the pod 104. The assembly costs, in particular in conjunction with the cranes required for that purpose and the assembly time, are also reduced by virtue of using the single-stage transmission 3 as smaller loads have to be conveyed up to the pod 104 of the wind turbine 100.

1. A wind turbine, comprising:
a main shaft;
a generator for generating electric power including:
a generator rotor coupled to the main shaft; and
a generator stator; and
a rotor blade hub, coupled to the main shaft, including:
a connecting portion for torque-transmitting coupling of the rotor blade hub to the main shaft; and
a single-stage transmission that is non-rotatably mounted to the rotor blade hub at a drive input side and has a connecting portion at a drive output side, wherein the single-stage transmission is in a form of an attachment transmission and is mounted at a side of the rotor blade hub that is remote from a machine carrier, wherein the rotor blade hub is arranged on a first side of the machine carrier, the generator is arranged on a second side of the machine carrier opposite to the first side, and the main shaft is passed through the machine carrier and is non-rotatably coupled to the generator rotor.

2. The wind turbine as claimed in claim 1, wherein the single-stage transmission is a planetary transmission having a sun gear, a planetary carrier having a plurality of planetary gears, and a ring gear, wherein the plurality of planetary gears engage the sun gear and the ring gear.

3. The wind turbine as claimed in claim 2, wherein the sun gear is non-rotatably coupled to the connecting portion of the single-stage transmission at the drive output side.

4. The wind turbine as claimed in claim 2, wherein the planetary carrier is non-rotatably coupled to the rotor blade hub at the drive input side.

5. The wind turbine as set forth in claim 3, wherein the connecting portion of the single-stage transmission is a first connecting portion and the ring gear has a second connecting portion for non-rotatable coupling to a journal of the wind turbine.

6. The wind turbine as claimed in claim 2, wherein the connecting portion of the single-stage transmission is a first connecting portion and the planetary carrier has a second connecting portion for non-rotatable coupling to a journal of the wind turbine.

7. The wind turbine as claimed in claim 2, wherein the ring gear of the planetary transmission is non-rotatably coupled to the rotor blade hub at the drive input side.

8. The wind turbine as claimed in claim 2, wherein the single-stage transmission is a magnetic transmission having an inner permanent-magnetic ring in place of the sun gear, a ferromagnetic intermediate ring in place of the planetary carrier, and an outer permanent-magnetic ring in place of the ring gear.

9. (canceled)

10. The wind turbine as claimed in claim 1 wherein the generator is a synchronous generator.

11. (canceled)

12. The wind turbine as claimed in claim 1, comprising:
a journal mounted on the machine carrier, wherein a generator module including the generator is mounted directly on the machine carrier, and the rotor blade hub is rotatably mounted on the journal.

13. The wind turbine as claimed in claim 1, wherein the main shaft is a hollow shaft.
